(19) United States
(12) Patent Application Publication
(10) Pub. No.: US 2012/0072406 A1
(43) Pub. Date: Mar. 22, 2012

(54) SEARCH PROCESSING METHOD AND APPARATUS

(75) Inventors: Tomoya IWAKURA, Kawasaki (JP); Seishi Okamoto, Kawasaki (JP)

(73) Assignee: FUJITSU LIMITED, Kawasaki (JP)

(21) Appl. No.: 13/234,955

(22) Filed: Sep. 16, 2011

Related U.S. Application Data
(63) Continuation of application No. PCT/JP2009/055177, filed on Mar. 17, 2009.

(51) Int. Cl. G06F 17/30

(52) U.S. Cl. 707/706; 707/E17.108

(57) ABSTRACT

By carrying out search by a search keyword inputted by a searcher, an initial search result is obtained. On the other hand, extended search keywords associated with the search keyword are extracted to count the number of pertinent keywords or appearance frequency in the initial search result. Then, when the number of pertinent documents or appearance frequency is equal to or less than a predetermined value (including 0), the extended search keyword is adopted, and by carrying out search by the search keyword and adopted extended search keyword, extended search results are obtained. Then, the initial search result and extended search results are shown to the searcher.

### CROSS-REFERENCE TO RELATED APPLICATIONS

This application is a continuing application, filed under 35 U.S.C. section 111(a), of International Application PCT/JP2009/055177, filed Mar. 17, 2009.

### FIELD

This technique relates to a keyword search technique.

### BACKGROUND

Conventionally, when a database search is carried out, for example, by a keyword “apple”, it is assumed that a search result as illustrated in FIG. 1 is obtained. As understood from FIG. 1, top 1000 documents in the search result include only documents as to “apple juice” and “apple jam” . Generally, a search engine restricts the number of documents to be replied as the search result, and a searcher cannot access documents such as documents including, for example, “apple pie” after the top 1000 documents, for example.

Moreover, a conventional technique exists, in which related terms associated with an input keyword are extracted from an association dictionary storing related terms for each keyword in advance, and a search is carried out by further using the extracted related terms. The related terms are extracted based on predetermined priority degrees or the like. However, even when the related terms such as “juice” or “jam” are added to carry out additional search in such a state that the search result as illustrated in FIG. 1 is obtained, almost similar search result to the search result in FIG. 1 is obtained as illustrated in FIG. 2. Therefore, a searcher cannot obtain much effective additional information.

In addition, a technique also exist, that, when a number of hits is obtained as the search result of the documents, additional search words are extracted in order of the appearance frequency from neighbors of the search words (neighbors in the documents), the association of the respective words is layered and displayed, and terms selected from among them are added to a search condition to carry out a narrowing search. However, because neighboring terms within the documents are extracted as additional search words, the possibility is high that documents that can be obtained only by the input keyword are extracted.

Therefore, an object of this technique is to provide a new technique for enabling to automatically show search results having contents different from contents of the search result that is obtained from the input search keyword.

### SUMMARY

This search processing method includes: receiving a search keyword; causing a search engine to search a database storing data concerning documents by the received search keyword, obtaining an initial search result including text data of at least one portion of pertinent documents from the search engine, and storing the initial search result into an initial search result storage unit; extracting extended search keywords associated with the received search keyword from an extended search keyword storage unit storing extended search keywords in association with each keyword; searching the initial search result storage unit by each of the extracted extended search keywords to count the number of pertinent documents or appearance frequency for each of the extracted extended search keywords, and storing the number of pertinent documents or appearance frequency into a totaling result storage unit in association with each of the extracted extended search keywords; causing the search engine to search the database by a combination of the received search keyword and either of each of a top predetermined number of extended search keywords in an ascending order of the number of pertinent documents or the appearance frequency among the extended search keywords stored in the totaling result storage unit and each of the received search keywords whose number of pertinent documents or appearance frequency is equal to or greater than a predetermined value, obtaining extended search results including text data of at least one portion of pertinent documents from the search engine, and storing the extended search results into an extended search result storage unit; and outputting at least one portion of the initial search result stored in the initial search result storage unit and at least one portion of the extended search results stored in the extended search result storage unit.

### BRIEF DESCRIPTION OF DRAWINGS

FIG. 1 is a diagram to explain conventional arts;

FIG. 2 is a diagram to explain conventional arts;

FIG. 3 is a diagram depicting a system outline relating to an embodiment;

FIG. 4 is a diagram depicting a main processing flow;

FIG. 5 is a diagram depicting a processing flow of an initial search processing

FIG. 6 is a diagram depicting an example of a search keyword input screen;

FIG. 7 is a diagram depicting an example of data stored in a session DB;

FIG. 8 is a diagram depicting an example of data stored in an initial search result DB;

FIG. 9 is a diagram depicting a processing flow of an extended keyword selection processing;

FIG. 10 is a diagram depicting an example of data stored in an extended keyword DB;

FIG. 11 is a diagram depicting an example of data stored in an extended keyword candidate DB;

FIG. 12 is a diagram depicting an example of an extended keyword candidate list after sorting;

FIG. 13 is a diagram depicting a processing flow of an extended search processing;

FIG. 14 is a diagram depicting an example of data stored in an extended search result DB;

FIG. 15 is a diagram depicting a processing flow of a search result generation processing;

FIG. 16 is a diagram depicting an example of a search result display screen; and

FIG. 17 is a functional block diagram of a computer.

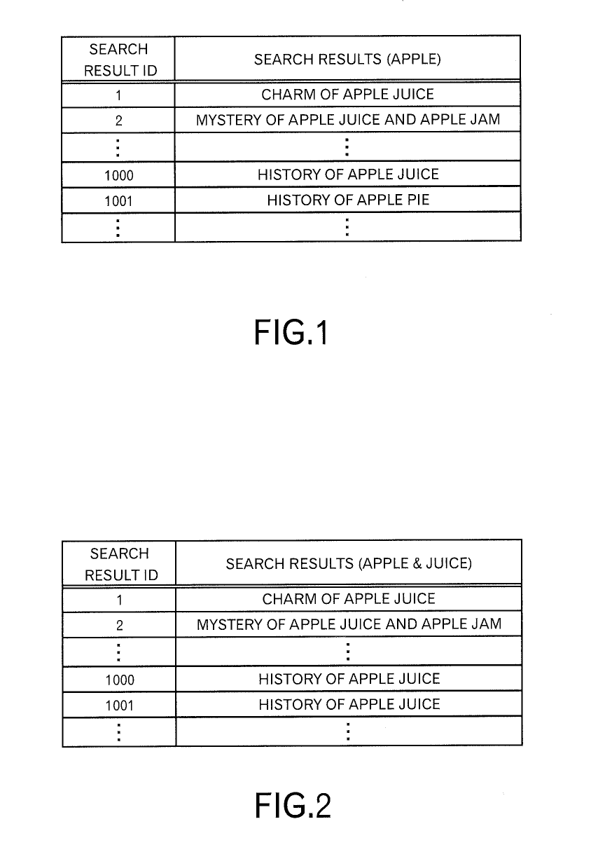

### DESCRIPTION OF EMBODIMENTS

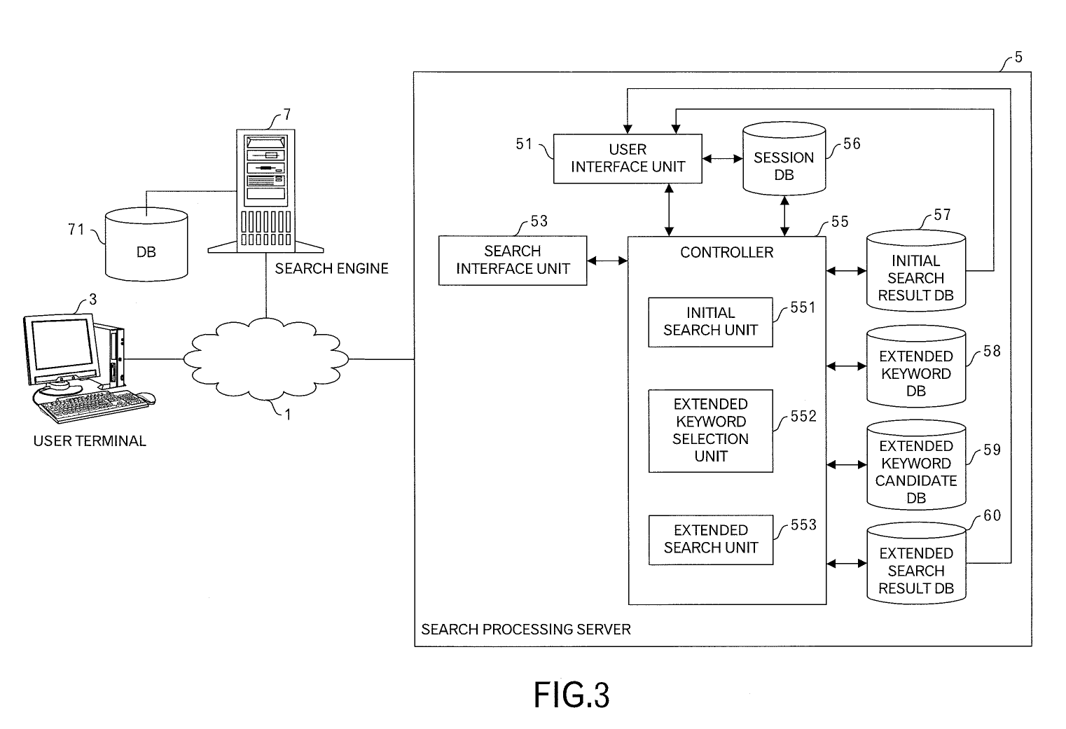

FIG. 3 illustrates an outline of a system relating to an embodiment of this technique. For example, plural user terminal 3, a search processing server 5 that carries out a main processing in this embodiment and a search engine 7 that carries out a well-known database search are connected to a computer network 1 such as the Internet or Local Area Network (LAN).

The search engine 7 is connected to the database (DB) 71, and documents themselves may be stored in this DB 71, or index data of a lot of documents (Web page data and the like), which are held by a lot of servers connected, for example, with the network 1, and the like may be held. Configurations of the search engine 7 and DB 71 managed by the search engine 7 are not main portions of this embodiment and are well-known. Therefore, further explanation is omitted.

In addition, the search processing server 5 has a user interface unit 51 that is an interface with the user terminals 3; search interface unit 53 that is an interface with the search engine 7; controller 55; session DB 56; initial search result DB 57; extended keyword DB 58; extended keyword candidate DB 59; and extended search result DB 60. The controller 55 operates with the user interface unit 51 and search interface unit 53.

Moreover, the controller 55 has an initial search unit 551 that carries out a processing by using data stored in the session DB 56 and stores an initial search result into the initial search result DB 57; extended keyword selection unit 552 that carries out a processing by using data stored in the initial search result DB 57 and extended keyword DB 58 and stores processing results into the extended keyword candidate DB 59; and extended search unit 553 that carries out a processing by using data stored in the session DB 56 and extended keyword DB 58, and stores processing results into the extended search result DB 60.

The user interface unit 51 registers data received from the user terminals 3 into the session DB 56, generates search result display data by using data stored in the initial search result DB 57 and extended search result DB 60, and transmits the search result display data to the user terminal 3.

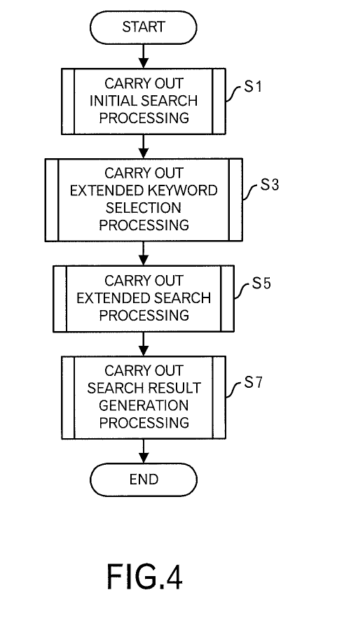

Next, an operation of the system illustrated in FIG. 3 will be explained by using FIGS. 4 to 16. First, an outline of the processing is illustrated in FIG. 4. First, an initial search processing is carried out (step S1). The initial search processing will be explained in detail later. However, this processing is similar to a normal search processing. Next, an extended keyword selection processing is carried out (step S3). The extended search selection processing will be explained in detail later. However, an extended keyword candidate to be used in addition to the input search keyword is selected. However, the step S3 may be carried out in parallel with the step S1. Moreover, when they are carried out serially, the step S3 may be executed prior to the step S1. After that, an extended search processing is carried out (step S5). The extended search processing will be explained in detail later. However, the search processing is carried out for combinations of the input search keyword and the extended keyword candidate. Finally, a search result generation processing is carried out (step S7). The search result generation processing will be explained in detail later. However, this is a processing to generate Web page data for displaying the initial search result and extended search result, which are collocated on one screen, for example, up and down or right and left, and to transmit and display the Web page data to the user terminal 3.

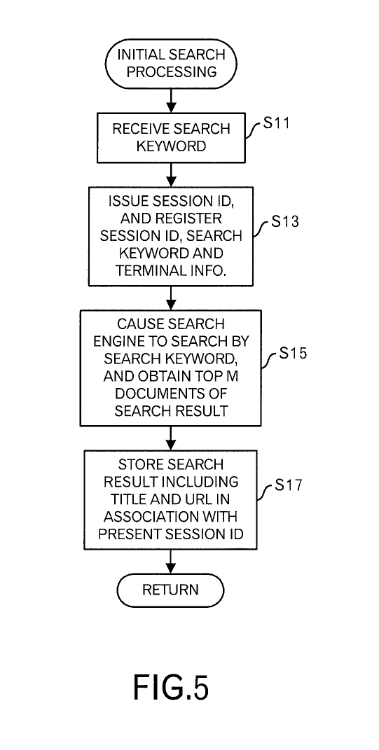

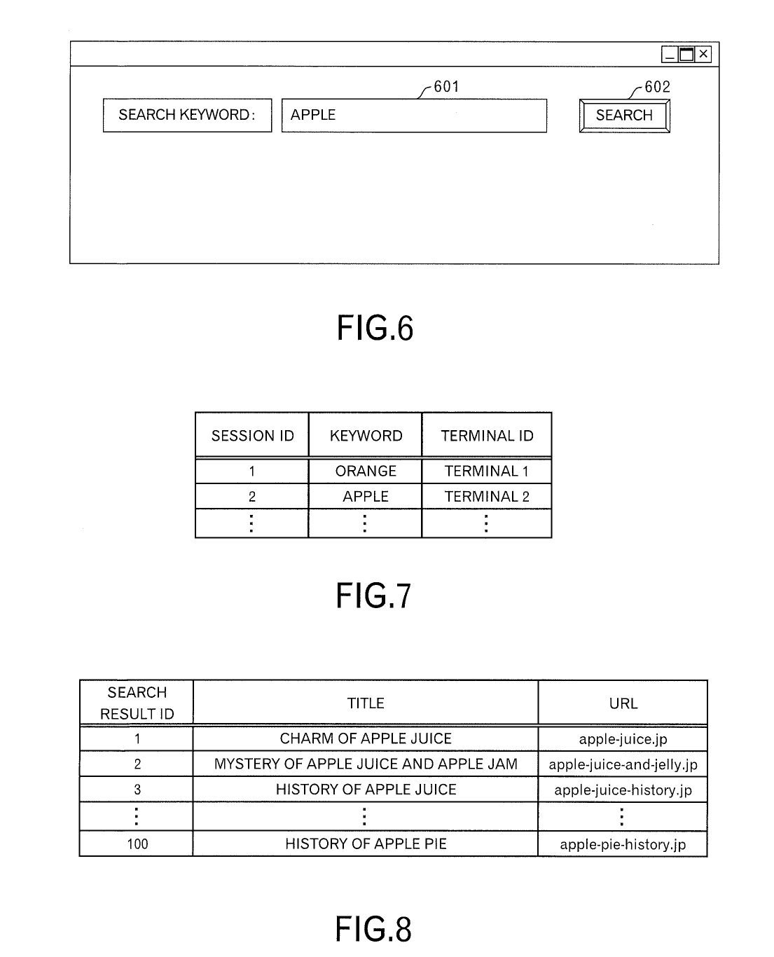

Next, the initial search processing is explained by using FIG. 5. First, the user interface unit 51 of the search processing server 5 receives a search keyword from the user terminal 3 (step S11). For example, in response to an access from the user terminal 3, the user interface unit 51 transmits Web page data for displaying a search keyword input screen to the user terminal 3, and the user terminal 3 receives the Web page data, and displays the search keyword input screen as illustrated in FIG. 6. A screen example of FIG. 6 has an input column 601 and search button 602. Here, it is assumed that a search keyword “apple” is inputted into the input column 601, and the search button 602 is clicked. The user terminal 3 transmits the search keyword as a search request to the search processing server 5.

Next, the user interface unit 51 issues a session ID and registers the session ID, search keyword and terminal information (e.g. a terminal ID, IP address or the like) into the session DB 56 (step S13). For example, data as illustrated in FIG. 7 is registered into the session DB 56. In an example of FIG. 7, the session ID, keyword and terminal ID (IP address or the like in some cases) are registered. In addition, the user interface unit 51 instructs the controller 55 to carry out a processing.

For example, when a new record is registered into the session DB 56, the initial search unit 551 of the controller 55 reads out a newly registered search keyword from the session DB 56, and requests the search interface unit 53 to cause the search engine 7 to carry out the search by the search keyword. In response to the request from the initial search unit 551, the search interface unit 53 transmits a search request including the search keyword to the search engine 7. The search engine 7 receives the search request including the search keyword from the search processing server 5, carries out a search processing, for example, for the DB 71, and transmits data of the top M documents of the search result to the search processing server 5. The search interface unit 53 of the search processing server 5 receives data of the top M documents of the search result, and outputs the data to the initial search unit 551 of the controller 55. The initial search unit 551 obtains the data of the top M documents of the search result from the search interface unit 53. The search result includes titles and Uniform Resource Locators (URLs) of the corresponding documents, for example.

Then, the initial search unit 551 associates the present session ID and the data of the search result including the titles and URLs, and stores them into the initial search result DB 57 (step S17). For example, data as illustrated in FIG. 8 is registered into the initial search result DB 57. In an example of FIG. 8, a search result ID, title, and URL are registered. Incidentally, in this example, data of the top 100 documents is registered. In addition, the initial search result DB 57 stores, for each session ID, a table as illustrated in FIG. 8.

Thus, as normally obtained, the search result based on the inputted search keyword can be obtained.

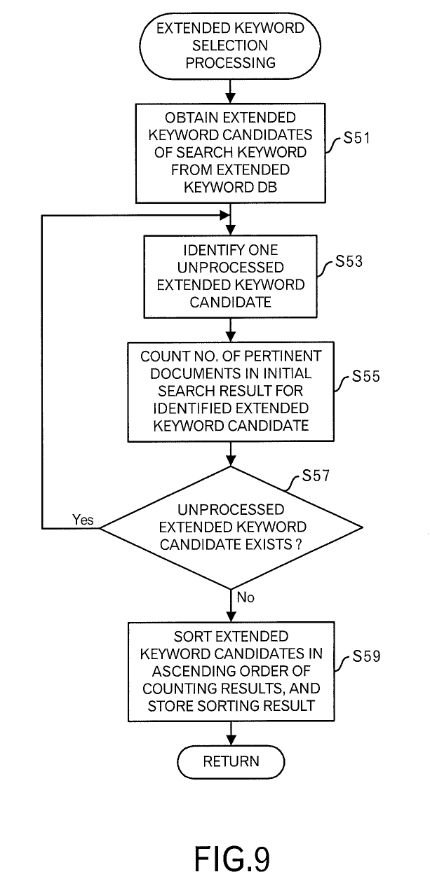

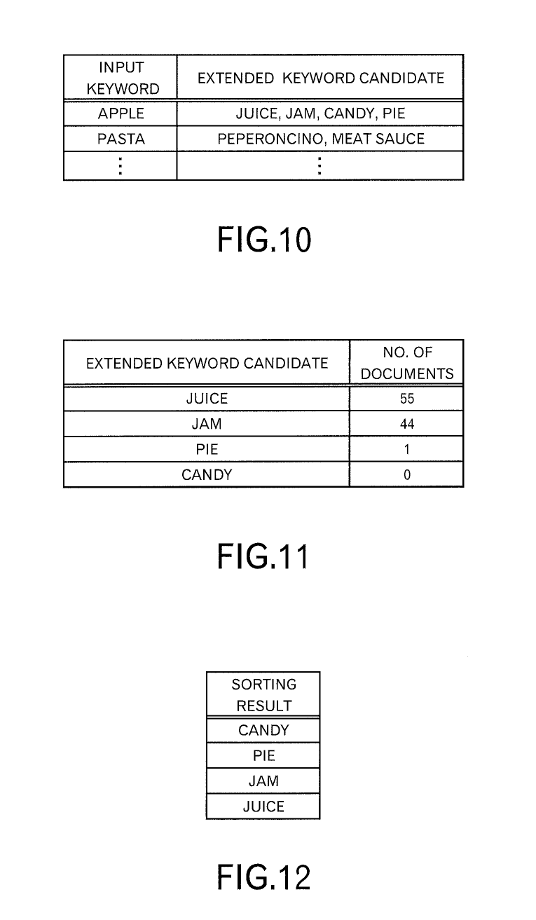

Next, the extended keyword selection processing is explained by using FIG. 9. The extended keyword selection unit 552 obtains extended keyword candidates corresponding to the search keyword from the extended keyword DB 58 (step S51). For example, data as illustrated in FIG. 10 is stored in the extended keyword DB 58. In an example of FIG. 10, the input keyword and corresponding extended keyword candidates are registered. For example, the extended keyword candidates such as “juice”, “jam”, “candy” and “pie” are registered for an input keyword “apple”.

Next, the extended keyword selection unit 552 identifies one unprocessed extended keyword candidate among the obtained extended keyword candidates (step S53). Then, the extended keyword selection unit 552 searches the initial search result DB 57 by using the identified extended keyword candidate to count the number of pertinent documents in the initial search result stored in the initial search result DB 57, and stores the number of pertinent documents into the extended keyword candidate DB 59 (step S55). For example, documents whose title includes the identified extended keyword candidate are determined as being pertinent among the documents in the initial search result DB 57, and the number of such documents is counted. For example, data as illustrated in FIG. 11 is stored in the extended keyword candidate DB 59. In an example of FIG. 11, for each extended keyword candidate, the number of pertinent documents is registered. Incidentally, instead of the number of pertinent documents, the appearance frequency may be counted and registered. In other words, when the title or the like is long and the same word appears twice or more in the title or the like in one document, the appearance frequency increases. Incidentally, when the step S55 is executed once, one line of FIG. 11 is registered.

Then, the extended keyword selection unit 552 determines whether or not any unprocessed extended keyword candidate exists (step S57). When there is an unprocessed extended keyword candidate, the processing returns to the step S53. On the other hand, when all of the extended keyword candidates have been processed, the extended keyword selection unit 552 sorts the extended keyword candidates based on the counting results (FIG. 11) in ascending order, and stores the sorting result into the extended keyword candidate DB 59 (step S59). In an example of FIG. 11, the counted value for “candy” is the minimum and the counted value for “juice” is the maximum. Therefore, a list of the extended keyword candidates as illustrated in FIG. 12 is obtained and registered into the extended keyword candidate DB 59. Then, the processing returns to the calling-source processing.

Incidentally, instead of the step S55, it may be determined whether or not the counted value is “0”, and when the counted value is “0”, the extended keyword candidate may be registered into the extended keyword candidate DB 59. By doing so, it is possible to identify the extended keyword candidate that is not included in the initial search result at all. Therefore, it becomes possible to obtain search results whose contents are completely different from the contents of the initial search result, in the following processing. In such a case, the extended keyword candidates whose counted value is “0” are held as a list of FIG. 12.

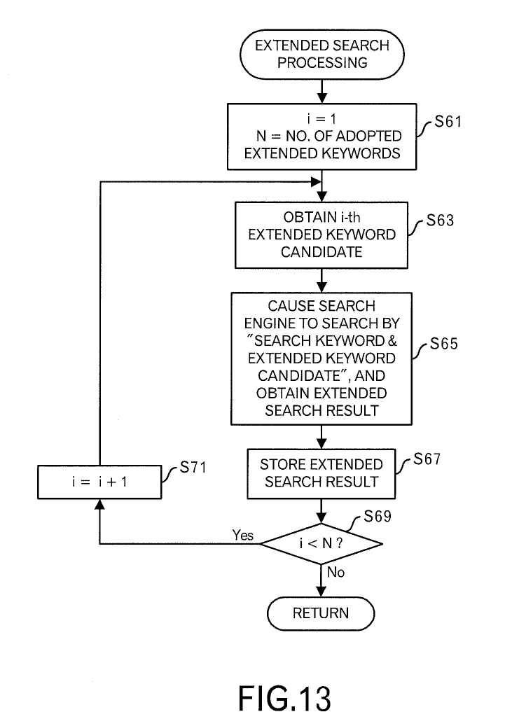

Next, the extended search processing is explained by using FIG. 13. First, the extended search unit 533 initializes a counter i to “1”, and sets the number of adopted extended keywords to N (step S61). Then, the extended search unit 533 obtains an i-th extended keyword candidate from the extended keyword candidate DB 59 (step S63). Then, the extended search unit 553 reads out a search keyword (i.e. search keyword associated with the present session ID) relating to the processing from the session DB 56, and requests the search interface unit 53 to cause the search engine 7 to carry out a processing for “search keyword & extended keyword candidate”. In response to the request from the extended search unit 553, the search interface unit 53 transmits a search request including “search keyword & extended keyword candidate” to the search engine 7. The search engine 7 receives the search request including “search keyword & extended keyword candidate” from the search processing server 5, carries out the search processing, for example, for the DB 71, and transmits data of the top M documents of the search result (i.e. extended search result) to the search processing server 5. The search interface unit 53 of the search processing server 5 receives data of the top M documents (M may be the same as M in the initial search processing or may be different from M in the initial search processing.) of the extended search result, and outputs the received data to the extended search unit 553 of the controller 55. The extended search unit 553 obtains data of the top M documents of the extended search result from the search interface unit 53 (step S65). The extended search result includes titles, Uniform Resource Locators (URL) of the pertinent documents, for example.

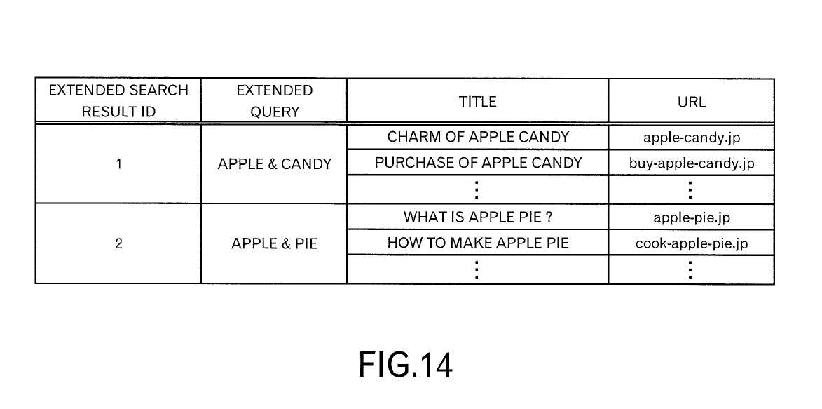

Then, the extended search unit 553 stores the obtained extended search result into the extended search result DB 60 (step S67). An example of data stored in the extended search result DB 60 is illustrated in FIG. 14. In the example of FIG. 14, for each extended search result ID, which is issued every time the step S65 is carried out, “search keyword & extended keyword candidate” , which is a condition of an extended query, title and URL are registered. For each extended search result ID, data of M documents is registered. In this embodiment, a data table as illustrated in FIG. 14 is stored for each session

ID into the extended search result DB 60.

Then, the extended search unit 553 determines whether or not i is less than N (step S69). When i is less than N, the extended search unit 553 increments i by 1 (step S71), and the processing returns to the step 563. On the other hand, when i is equal to or greater than N, the processing returns to the calling-source processing.

Thus, the extended search result to be shown to the searcher, which has contents that are not included very much in the initial search or are not included at all in the initial search, is obtained.

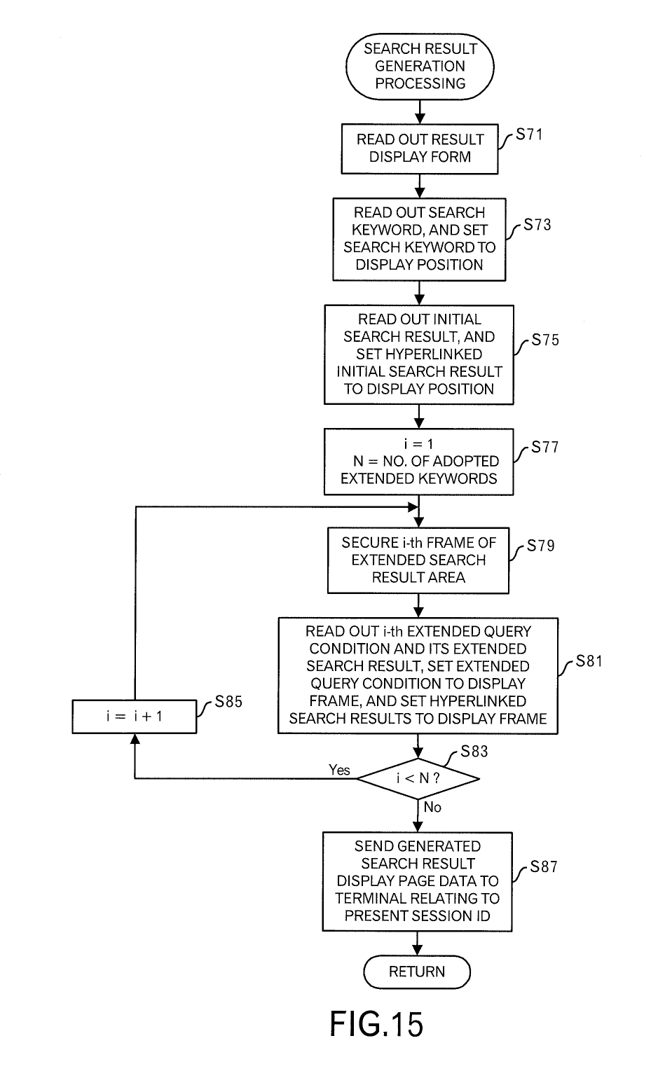

Next, the search result generation processing is explained by using FIG. 15. When the processing of the extended search unit 553 is complete, the controller 55 outputs the session ID whose processing is complete to the user interface unit 51 and causes the user interface unit 51 to carryout the search result generation processing.

The user interface unit 51 reads out a result display form, which is held (step S71), reads out the search keyword relating to the processing completion, for example, from the session DB 56, and sets the read search keyword to a display position in the result display form (step S73). In addition, the user interface unit 51 reads out the initial search result corresponding to the session ID relating to the processing completion from the initial search result DB 57, changes the title of each pertinent document to the hyperlinked title for the displayable pertinent documents so as to enable the access to the URL, and sets the hyperlinked title to the display position in the result display form (step S75). In addition, the user interface unit 51 initializes the counter i to “1”, and sets the number of adopted extended keywords to N (step S77).

Then, the user interface unit 51 secures an i-th frame in the extended search result area within the result display form (step S79), reads out the condition of the i-th extended query (i.e. “search keyword & extended keyword candidate”) and its extended search result from the extended search result DB 60, sets the extended query to its display frame in the result display form, changes the title of each pertinent document to the hyperlinked title for the displayable documents so as to enable the access to the URL, and sets the hyperlinked titles to the display position of the result display form (step S81).

Then, the user interface unit 51 determines whether or not i is less than N (step S83). When i is less than N, the user interface unit 51 increments i by 1 (step S85), and the processing returns to the step S79. On the other hand, when i is equal to or greater than N, the user interface unit 51 transmits a search result display page data based on the result display form, which was generated in the aforementioned processing, to the user terminal 3 relating to the present session ID (step S87).

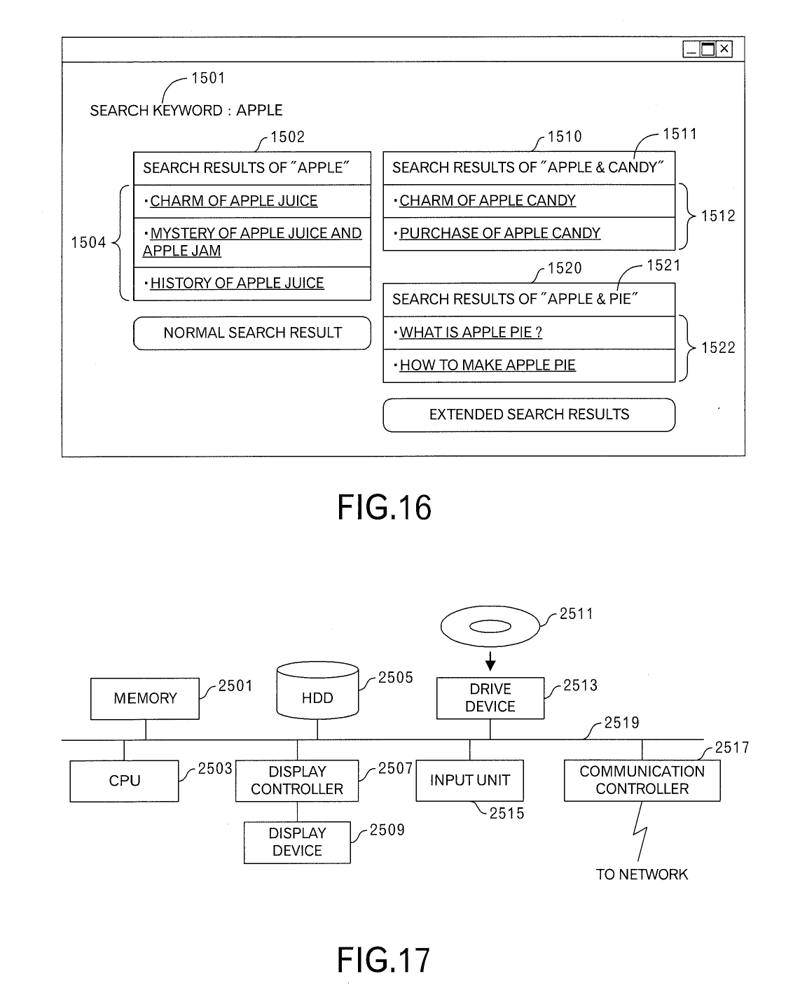

In response to this, the user terminal 3 receives the search result display page data from the search processing server 5, and displays the received data on a display device as illustrated in FIG. 16. In an example of FIG. 16, the search keywords are shown in a top portion 1501 of this page, a display frame 1502 of the initial search result by the search keyword is included at the left side under the portion 1501, and display frames 1510 and 1520 of the extended search results are provided at the right side of this display frame 1502. In a display frame 1504, the respective pertinent documents (Web page or the like) of the initial search result are listed, and it is possible to refer to the specific contents of the respective pertinent documents (e.g. Web page) via the hyperlinks.

Similarly, in the display frame 1511, the condition “apple & candy” of the extended query is shown, and the specific extended search results are listed in the display frame 1512. Similarly, in the display frame 1521, the condition “apple & pie” of the extended query is shown, and the specific extended search results are listed in the display frame 1522. Both frames include search results which are not displayed or are not easily displayed, when the search is carried out only by “apple”.

The number of pertinent documents that are displayed and the number of display frames of the extended search results depend on the size of the display area, but they are arbitrary. It is possible to divide this page into plural pages to separately display them. However, the display mode like FIG. 16 in which the comparison can be made is preferable. Incidentally, there is a case where all information is displayed on one window, but for example, the initial search result may be displayed on a first window and the extended search results may be separately displayed on a second window. Furthermore, for each extended keyword, the windows may be separated. Thus, more search results can be displayed once for each extended keyword.

As described above, when the processing like this embodiment is carried out, the contents, which are not normally displayed to the searcher only by the input search keyword inputted by the searcher, can be displayed to the user as the extended search results. Therefore, it is possible to give a new awareness and/or viewpoint to the searcher. Especially, the documents, which are buried in the lower ranking among the search results when searching only by using the input search keyword, can be relieved.

Although one embodiment of this technique was explained, this technique is not limited to this embodiment. For example, the functional block diagram of the search processing server 5 in FIG. 3 is a mere example, and does not always correspond to an actual program module configuration. Furthermore, the network connection relationship illustrated in FIG. 3 is a mere example, and for example, the search engine 7 may be connected to the network behind the search processing server 5 when viewed from the user terminal 3, as a server that operates in the background of the search processing server 5. Furthermore, although an example of the server-client configuration is illustrated, a stand-alone type configuration, in which the user terminal 3 and search processing server 5 are integrated into one computer, may be adopted. Furthermore, the search engine 7 may also be integrated.

Furthermore, as for the processing flow, as long as the processing results do not change, the order of the steps may be changed, or the steps may be executed in parallel.

Incidentally, in the aforementioned example, a case where one input search keyword was used was explained. However, even when two or more search keywords are used, it is possible to basically cope with such a case by the same processing. Namely, for each of the plural input search keywords, the extended keyword candidates are extracted, and the aforementioned processing is carried out.

Furthermore, although the screen configuration example is illustrated, other screen configurations can be adopted, when it is possible to show similar information.

In addition, the search processing server 5, search engine 7 and user terminals 3 are computer devices as shown in FIG. 17. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 17. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are outlined as follows:

This search processing method includes: receiving a search keyword; causing a search engine to search a database storing data concerning documents by the received search keyword, obtaining an initial search result including text data of at least one portion of pertinent documents from the search engine, and storing the initial search result into an initial search result storage unit; extracting extended search keywords associated with the received search keyword from an extended search keyword storage unit storing extended search keywords in association with each keyword; searching the initial search result storage unit by each of the extracted extended search keywords to count the number of pertinent documents or appearance frequency for each of the extracted extended search keywords, and storing the number of pertinent documents or appearance frequency into a totaling result storage unit in association with each of the extracted extended search keywords; causing the search engine to search the database by a combination of the received search keyword and either of each of a top predetermined number of extended search keywords in an ascending order of the number of pertinent documents or the appearance frequency among the extended search keywords stored in the totaling result storage unit and each of the received search keywords whose number of pertinent documents or appearance frequency is equal to or greater than a predetermined value, obtaining extended search results including text data of at least one portion of pertinent documents from the search engine, and storing the extended search results into an extended search result storage unit; and outputting at least one portion of the initial search result stored in the initial search result storage unit and at least one portion of the extended search results stored in the extended search result storage unit.

Thus, by using, in the extended search, extended search keywords that do not appear so much (or at all) in the search result (i.e. the initial search result) obtained by the input search keyword among the extended search keywords associated with the input search keyword, it becomes possible to show search results having contents or viewpoint different from that of the search result only by the input search keyword to the searcher.

Moreover, in the aforementioned outputting, data to display at least one portion of the initial search result and at least one portion of the extended search results in different screen areas may be generated. By arranging the aforementioned portions up and down or left and right in order to show them, it becomes possible for the searcher to grasp different search results while comparing them, and it is also possible to find out documents much similar to the target or find out a new search direction. Incidentally, the same window may be divided into different areas, or for example, the initial search result may be displayed on a main window and the extended search results may be displayed on one or plural sub-windows.

Furthermore, the aforementioned predetermined value may be “0”. It becomes possible to show the search results having different contents that cannot be shown at all in the initial search result by the input search keyword. Incidentally, a range included in the initial search result is limited to the top predetermined number of documents and the extended search keywords are not included in such a range. However, the extended search keyword is included in documents ranked under the top predetermined number of documents.

Incidentally, it is possible to create a program causing a computer to execute the aforementioned processing, and such a program is stores in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

What is claimed is:

1. A non-transitory computer-readable storage medium storing a search processing program for causing a computer to execute a process comprising:
receiving a search keyword;
causing a search engine to search a database storing data concerning documents by the received search keyword;
obtaining an initial search result including text data of at least one portion of pertinent documents from the search engine;
extracting extended search keywords associated with the received search keyword from an extended search keyword storage unit storing extended search keywords in association with each keyword;
searching the initial search result by each of the extracted extended search keywords to count the number of pertinent documents or appearance frequency for each of the extracted extended search keywords;
causing the search engine to search the database by a combination of the received search keyword and either of each of a top predetermined number of extended search keywords in an ascending order of the number of pertinent documents or the appearance frequency among the extended search keywords and each of the received search keywords whose number of pertinent documents or appearance frequency is equal to or greater than a predetermined value;
obtaining extended search results including text data of at least one portion of pertinent documents from the search engine; and
outputting at least one portion of the initial search result and at least one portion of the extended search results.

2. The non-transitory computer-readable storage medium as set forth in claim 1, wherein in the outputting, data to display at least one portion of the initial search result and at least one portion of the extended search results in different screen areas is generated.

3. The non-transitory computer-readable storage medium as set forth in claim 1, wherein the predetermined value is 0.

4. A search processing method, comprising:
receiving, by a computer, a search keyword;
causing, by the computer, a search engine to search a database storing data concerning documents by the received search keyword;
obtaining, by the computer, an initial search result including text data of at least one portion of pertinent documents from the search engine;
extracting, by the computer, extended search keywords associated with the received search keyword from an extended search keyword storage unit storing extended search keywords in association with each keyword;
searching, by the computer, the initial search result by each of the extracted extended search keywords to count the number of pertinent documents or appearance frequency for each of the extracted extended search keywords;
causing, by the computer, the search engine to search the database by a combination of the received search keyword and either of each of a top predetermined number of extended search keywords in an ascending order of the number of pertinent documents or the appearance frequency among the extended search keywords and each of the received search keywords whose number of pertinent documents or appearance frequency is equal to or greater than a predetermined value;
obtaining, by the computer, extended search results including text data of at least one portion of pertinent documents from the search engine; and
outputting, by the computer, at least one portion of the initial search result and at least one portion of the extended search results.

5. The search processing method as set forth in claim 4, wherein in the outputting, data to display at least one portion of the initial search result and at least one portion of the extended search results in different screen areas is generated.

6. A search processing apparatus, comprising:
a first unit that receives a search keyword;
a second unit that causes a search engine to search a database storing data concerning documents by the received search keyword, and obtains an initial search result including text data of at least one portion of pertinent documents from the search engine;
an extended search keyword storage unit storing extended search keywords in association with each keyword;
a third unit that extracts extended search keywords associated with the received search keyword from the extended search keyword storage unit; and
a fourth unit that searches the initial search result by each of the extracted extended search keywords to count the number of pertinent documents or appearance frequency for each of the extracted extended search keywords, and
wherein the second unit causes the search engine to search the database by a combination of the received search keyword and either of each of a top predetermined number of extended search keywords in an ascending order of the number of pertinent documents or the appearance frequency among the extended search keywords and each of the received search keywords whose number of pertinent documents or appearance frequency is equal to or greater than a predetermined value, and obtains extended search results including text data of at least one portion of pertinent documents from the search engine, and
the first unit outputs at least one portion of the initial search result and at least one portion of the extended search results.

7. The search processing apparatus as set forth in claim 6, wherein the first unit generates data to display at least one portion of the initial search result and at least one portion of the extended search results in different screen areas.
